(19) United States
(12) Patent Application Publication
(10) Pub. No.: US 2009/0100927 A1
(43) Pub. Date: Apr. 23, 2009

(54) Multi-contact sensor connector with release mechanism

(76) Inventors: D Glenn Purcell, Edwardsburg, MI (US); James C. Elsesser, Elkhart, IN (US)

Correspondence Address: BAYER HEALTHCARE, LLC, 555 WHITE PLAINS ROAD, TARRYTOWN, NY, 10591, US

(21) Appl. No.: 11/921,063

(22) PCT Filed: May 31, 2006
(86) PCT No.: PCT/US2006/020844

§ 371 Date: Nov. 26, 2007

Related U.S. Application Data
(60) Provisional application No. 60/686,389, filed on Jun. 1, 2005.

(51) Int. Cl. G01D 11/24

(52) U.S. Cl. 73/431

(57) ABSTRACT

A multi-contact sensor connector for use with an instrument adapted to handle a sensor pack containing sensors. The sensors have a plurality of electrical contacts. The connector comprises a test sensor support frame, a printed circuit board connector surface, a plurality of contacts, and a contact holder. The support frame forms an opening therethrough to allow a test sensor to pass through. The support frame has an inclined surface region adapted to guide a test sensor into the opening and a generally horizontal surface region adapted to support the test sensor in the opening. The contacts interact with the electrical contacts. The contacts are positioned to secure the test sensor between the contacts and the horizontal surface region. The contacts are compressed by the support frame and are fixed relative to the printed circuit board connector surface. The contact holder is adapted to retain the contacts and to electrically isolate the respective contacts from one another.

### FIELD OF THE INVENTION

The present invention relates generally to a fluid-monitoring system and, more particularly, to a new and improved sensor connector and release mechanism for a meter or instrument for handling multiple sensors that are used in analyzing at least one analyte in a fluid contained therein (e.g., blood glucose, cholesterol).

### BACKGROUND OF THE INVENTION

People suffering from various forms of diabetes routinely need to test their blood to determine the level of blood glucose. The results of such tests can be used to determine what, if any, insulin or other medication needs to be administered. In one type of blood glucose testing system, sensors are used to test a sample of blood.

Such a sensor may have a generally flat, rectangular shape with a front or testing end and a rear or contact end. The sensor contains biosensing or reagent material that will react with blood glucose. The testing end of the sensor is adapted to be placed into the fluid being tested, for example, blood that has accumulated on a person's finger after the finger has been pricked. The fluid is drawn into a capillary channel that extends in the sensor from the testing end to the reagent material by capillary action so that a sufficient amount of fluid to be tested is drawn into the sensor. The fluid then chemically reacts with the reagent material in the sensor with the result that an electrical signal indicative of the blood glucose level in the blood being tested is supplied to contact areas located near the rear or contact end of the sensor.

To couple the electrical signals produced at the sensor contacts to monitoring equipment, the sensors need to be inserted into sensor holders prior to the sensor end being placed into the fluid being tested. The sensor holders have corresponding mating contact areas that become coupled to the contacts on the sensor when the sensor is inserted into the holder. Consequently, the holders act as an interface between the sensor and monitoring equipment that accumulates and/or analyzes the test results.

Prior to being used, the sensors typically need to be maintained at an appropriate humidity level so as to insure the integrity of the reagent materials in the sensor. Sensors can be packaged individually in tear-away packages so that they can be maintained at the proper humidity level. For instance, blister-type packaging methods could be used. In this connection, the packages can include desiccant material to maintain the proper humidity in the package. To use an individual sensor for testing blood glucose, the package must be opened by tearing the seal. Alternatively, some packages require the user to exert force against one side of the package resulting in the sensor bursting or rupturing the foil on the other side. As can be appreciated, the opening of these packages can be difficult. Moreover, once the package is opened, the user needs to be sure that the sensor is not damaged or contaminated as it is being placed into the sensor holder and used to test the blood sample.

Some users have experienced difficulties in the operation and/or manipulation of the prior art sensor instruments. For example, users with limited dexterity may find it difficult to remove a used sensor from the device. Because the used sensor contains blood or other fluids, the sensor should be disposed of immediately after the testing procedure is completed. Moreover, physical handling of the used sensor should be avoided to prevent or inhibit the spreading of blood-born diseases or other harmful contaminants. It is therefore desirable that the used sensor be removed from the device without being grasped or otherwise handled by the user.

One prior art technique involves discharging the used test sensor by sliding the slide latch away from the testing end of the device and simultaneously tipping the testing end of the device downwardly. This requires an awkward manipulation of the device that may be particularly difficult for users, particularly elderly users suffering from diabetes, which lack dexterity in their wrist, hand or fingers. As a result, many users may be tempted to grab the end of the used sensor to remove it from the device.

Another prior technique, such as that described in United States Patent Publication No. US 2003/0031591, discloses a button that is depressed to release a previously used test sensor from the sensor-dispensing instrument by moving sensor contacts of the testing device away from the test sensor. Aligning the test sensors to the contacts of the sensor-dispensing instrument becomes more difficult if the meter contacts move relative to the walls that position the test sensor. Additionally, the amount of contact force between the sensor-dispensing instrument and the test sensor, which is important in ensuring a robust electrical connection, is too variable in some prior devices. It is therefore desirable to have an improved sensor-dispensing instrument that utilizes an improved sensor connector wherein the variability in contact force between the sensor-dispensing instrument and the test sensor is decreased. It is additionally desirable to have an improved sensor connector wherein the contacts remain in a generally fixed location.

### SUMMARY OF THE INVENTION

According to one embodiment, a multi-contact sensor connector for use with a sensor-dispensing instrument adapted to handle a sensor pack containing a plurality of sensors. Each of the sensors has a plurality of electrical contacts. The multi-contact sensor connector comprises a test sensor support frame, a printed circuit board connector surface, a plurality of contacts, and a contact holder. The test sensor support frame forms an opening therethrough. The opening is adapted to allow a test sensor to pass through. The test sensor support frame has an inclined surface region adapted to guide a test sensor into the opening as well as a generally horizontal surface region adapted to support the test sensor in the opening. The plurality of contacts are adapted to interact with electrical contacts of the sensor. The contacts are positioned to secure the test sensor between the contacts and the generally horizontal surface region of the test sensor support frame. The contacts are compressed by the test sensor support frame. The contacts are fixed relative to the printed circuit board connector surface. The contact holder is adapted to retain the plurality of contacts and to electrically isolate the respective contacts from one another.

According to another embodiment, a multi-contact sensor connector for use with a sensor-dispensing instrument adapted to handle a sensor pack containing a plurality of sensors. Each of the sensors has a plurality of electrical contacts. The multi-contact sensor connector comprises a test sensor support frame, a plurality of contacts, a contact holder, and a sensor release button. The test sensor support frame forms an opening therethrough. The opening is adapted to allow a test sensor to pass through. The test sensor support frame has an inclined surface region adapted to guide a test sensor into the opening and a generally horizontal surface region adapted to support the test sensor in the opening. The plurality of contacts are adapted to interact with electrical contacts of the sensor. The contacts are fixedly positioned opposite the generally horizontal surface region of the test sensor support frame to secure the test sensor between the contacts and the generally horizontal surface region of the test sensor support frame. The contacts are compressible by the test sensor support frame. The contact holder is adapted to retain the plurality of contacts. The contact holder has a first sidewall and a second sidewall. The sensor release button is adapted to vertically displace the sensor support frame from the contacts, thereby releasing the test sensor when the sensor release button is depressed. The first sidewall and the second sidewall are adapted to laterally position the test sensor relative to the plurality of contacts.

According to a further embodiment of the present invention, an electrical contact carrier assembly for use with a multi-contact sensor connector comprises a plurality of electrical contacts, and a removable attachment member. The plurality of electrical contacts has a generally identical profile. The removable attachment member is adapted to removably connect the plurality of electrical contacts and provide proper lateral spacing between the contacts.

The above summary of the present invention is not intended to represent each embodiment, or every aspect, of the present invention. Additional features and benefits of the present invention are apparent from the detailed description and figures set forth below.

### BRIEF DESCRIPTION OF THE DRAWINGS

FIG. 1 is a top perspective view of a sensor-dispensing instrument according to one embodiment of the present invention.

FIG. 2 is a bottom perspective view of the sensor-dispensing instrument of FIG. 1.

FIG. 3 is a perspective view of the sensor-dispensing instrument of FIG. 1 in the opened position showing the insertion of a sensor pack.

FIG. 4 is an exploded perspective view of the component parts of a sensor pack used with one embodiment of the present invention.

FIG. 5 is a perspective view of a test sensor used with one embodiment of the present invention.

FIG. 6 is a rear perspective view of a multi-contact sensor connector according to one embodiment of the present invention.

FIG. 7 is a front perspective view of the multi-contact sensor connector of FIG. 6.

FIG. 8 is a front view of a contact holder of the multi-contact sensor connector of FIG. 6.

FIG. 9 is a front view of the multi-contact sensor connector of FIG. 6.

FIG. 10 is a cross-sectional view taken generally through line 10-10 of FIG. 9.

FIG. 11 is a front view of the multi-contact sensor connector of FIG. 6 in a testing position.

FIG. 12 is a cross-sectional view taken generally through line 12-12 of FIG. 11.

FIG. 13 is a front view of the multi-contact sensor connector of FIG. 6 in a release position.

FIG. 14 is a cross-sectional view taken generally through line 14-14 of FIG. 13.

FIG. 15a is a perspective view of a contact holder showing contacts in a first position being assembled to the contact holder.

FIG. 15b is a perspective view of a contact holder showing contacts in a second position being assembled to the contact holder.

FIG. 15c is a perspective view of a contact holder showing contacts in a third position being assembled to the contact holder.

### DESCRIPTION OF ILLUSTRATED EMBODIMENTS

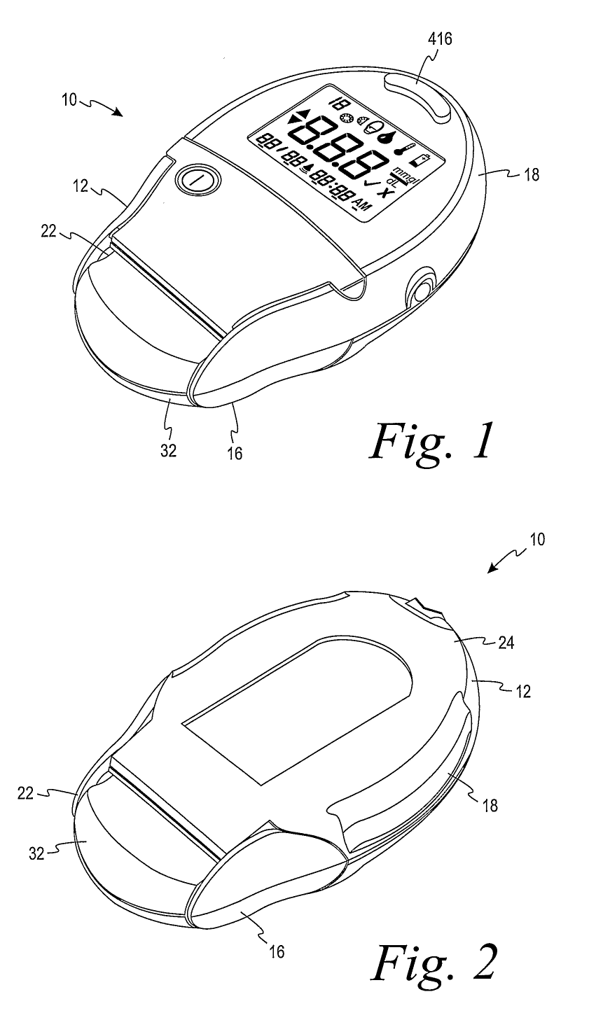

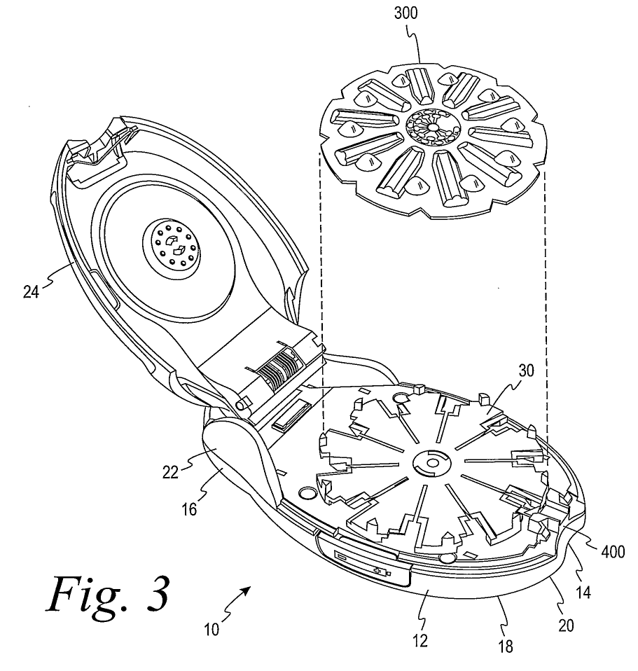

Referring now to FIGS. 1 and 2, a sensor-dispensing instrument 10 is shown that may be used in determining concentration of at least one analyte in a fluid. Analytes that may be measured using the present invention include glucose, lipid profiles (e.g., cholesterol, triglycerides, LDL and HDL), microalbumin, hemoglobin Alc, fructose, lactate, or bilirubin. The present invention is not limited, however, to these specific analytes and it is contemplated that other analyte concentrations may be determined. The analytes may be in, for example, a whole blood sample, a blood serum sample, a blood plasma sample, or other body fluids like ISF (interstitial fluid) and urine. The sensor-dispensing instrument 10 includes an outer housing 12 having an upper case 18 and a lower case 24, the lower case 24 pivoting on the upper case 18. The upper case 18 is pivotable with respect to the lower case 24 in a clamshell fashion so that a sensor pack 300 (see FIG. 3) can be positioned on an indexing disk 30 within the housing 12. With the sensor pack 300 so loaded in the housing 12, a puller handle 32 extending from a rear end 22 of the upper case 18 of the housing 12 can be moved to activate a disk-drive mechanism, to load a sensor 302 (FIG. 5) into a testing position on the front end 14 of the housing 12 (see FIG. 3).

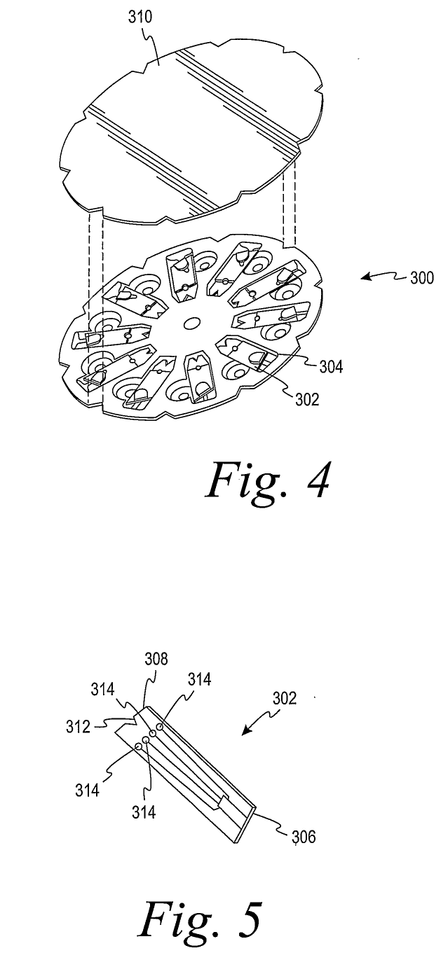

As shown in FIG. 4, the sensor pack 300 utilized by the sensor-dispensing instrument 10 is of the type described in U.S. Pat. No. 5,575,403, issued Nov. 19, 1996, entitled “Dispensing Instrument For Fluid Monitoring Sensors.” In general, the sensor pack 300 is adapted to house a plurality of test sensors 302 with each of the test sensors 302 in a respective one of a plurality of separate sensor cavities 304. As depicted in FIG. 5, each of the sensors 302 has a generally flat, rectangular shape extending from a front or testing end 306 to a back end 308. The front end 306 is angled so that it will puncture an unsevered portion of protective foil 310 overlying the sensor cavity 304 as the sensor 302 is being forced out of the sensor cavity 304 by a knife blade. The front end 306 is also adapted to be placed into a fluid (e.g., blood) that is being analyzed. The back end 308 of the sensor includes a small notch 312 that is engaged by a knife blade as the knife blade ejects the sensor 302 from the sensor cavity 304. Contacts 314 near the back end 308 of the sensor 302 are adapted to mate with metal contacts on a multi-contact sensor connector 400 (to be described below) when the sensor 302 is in a testing position. As a result, the sensor is coupled to the electronic circuitry on a circuit board assembly so that information generated in the sensor during testing can be stored, analyzed and/or displayed.

To operate the sensor-dispensing instrument 10, the puller handle 32 is first manually pulled from a standby position (FIG. 1) adjacent the rear end 16 of the housing 12 to an extended position away from the rear end 16 of the housing 12. The outward movement of the puller handle 32 causes a disk-drive mechanism to rotate the sensor pack 300 and place the next sensor 302 in a standby position prior to being loaded into a testing position. The outward movement of the puller handle 32 also causes the sensor-dispensing instrument 10 to turn ON (i.e., the electronic circuitry on the circuit board assembly is activated).

The puller handle 32 is then manually pushed inwardly from the extended position back past the standby position (FIG. 1) and into a testing position. The inward movement of the puller handle 32 causes the disk-drive mechanism to remove a sensor 302 from the sensor pack 300 and place the sensor 302 into a multi-contact sensor connector 400 on the front end 14 of the housing 12 wherein testing may occur.

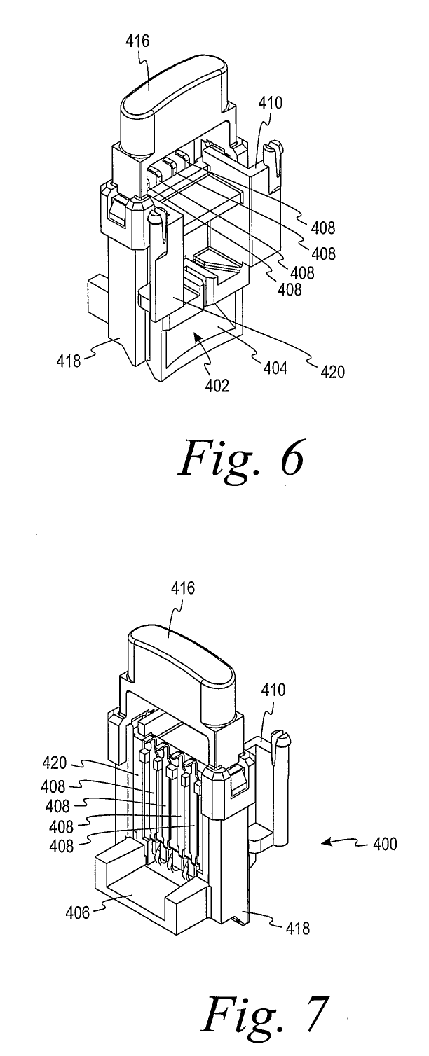

Turning now to FIGS. 6-14, a multi-contact sensor connector 400 is shown according to one embodiment of the present invention. The multi-contact sensor connector 400 is adapted to work with a sensor-dispensing instrument such as the sensor-dispensing instrument 10. While the multi-contact sensor connector 400 has been described in connection with a sensor-dispensing instrument utilizing a disk-type sensor pack, it is further contemplated that the multi-contact sensor connector may be utilized in conjunction with sensor-dispensing instrument utilizing a cartridge-type sensor pack, or other sensor packs known in the art. The multi-contact sensor connector 400 has a test sensor support frame 418 forming an opening 402 therethrough (FIG. 10). The opening 402 is adapted to allow the sensor 302 to pass therethrough as the sensor is removed from a sensor pack. The test sensor support frame 418 has an inclined surface 404 that the test sensor 302 slides up as the test sensor 302 enters the multi-contact sensor connector 400. The inclined surface 404 helps to guide the test sensor 302 into the multi-contact sensor connector 400 without causing high resistive forces to be placed on the test sensor 302 that could damage the test sensor 302, or make the operation of the sensor-dispensing instrument difficult. The test sensor support frame 418 additionally has a generally horizontal surface 406. The generally horizontal surface is adapted to help support the test sensor 302 in a testing position.

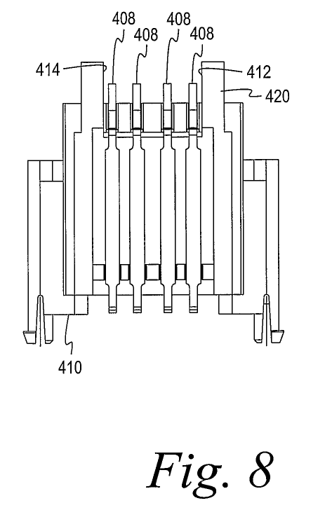

As shown in FIG. 7, the multi-contact sensor connector 400 has a plurality of contacts 408 that are adapted to interact with the contacts 306 of the test sensor 300 to electrically couple the test sensor 302 to a sensor-dispensing instrument. Four contacts 408 are shown in FIGS. 6-15, however it is contemplated that the number of contacts used on a multi-contact sensor connector may vary in alternative embodiments. The contacts 408 are further adapted to interact with a printed circuit board (“PCB”) connector (not shown) positioned on a generally horizontal PCB connector surface 410 of the multi-contact sensor connector 400. The PCB connector is adapted to electrically couple the contacts 408 to the sensor-dispensing instrument. The contacts 408 are contained within a contact holder 420 (FIG. 8). The contact holder 420 supports the contacts 408 and further serves to electrically isolate each of the contacts 408.

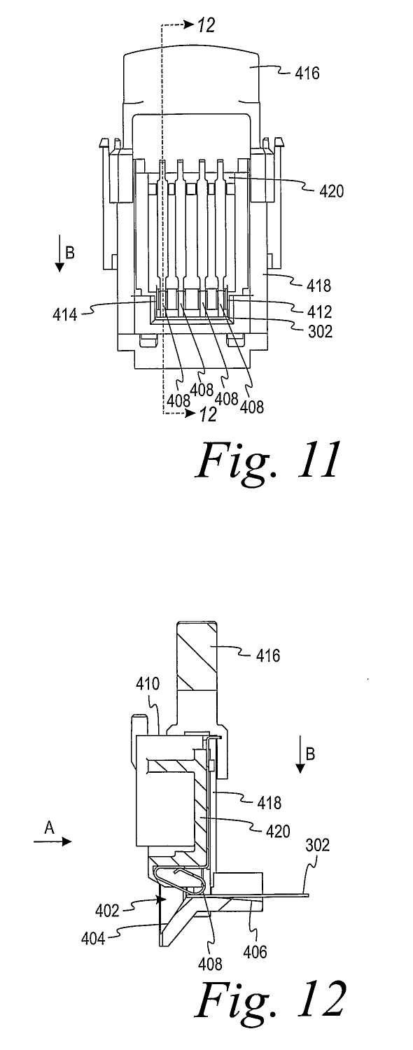

The contacts 408 are adapted to interact with the generally horizontal surface 406 of the opening 402 in order to secure a test sensor in the testing position, as shown in FIGS. 11 and 12. While the test sensor is in the testing position, the contacts 408 of the multi-contact sensor connector 400 touch the contacts 314 of the test sensor 302, electrically coupling the test sensor 302 to the sensor-dispensing instrument. The contacts 408 exert a force on the test sensor 302 to secure the test sensor 302 between the contacts 408 and the generally horizontal surface 406 of the test sensor support frame 418.

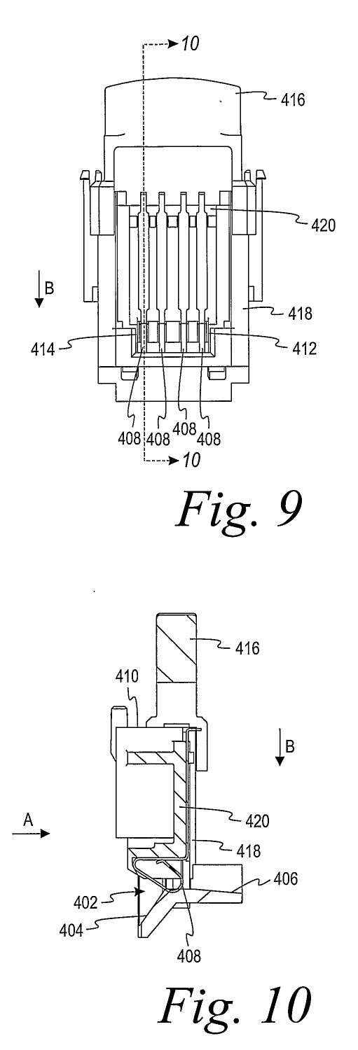

To ensure that sufficient force is exerted on the test sensor 302 by the contacts 408, the contacts 408 are designed to have a pre-load. The pre-load of the contacts 408 is achieved by designing the contacts 408 such that the generally horizontal surface 406 touches the contacts 408, compressing the contacts 408 an amount. According to one embodiment it is contemplated that the contacts are compressed about 0.008 inch. When the test sensor 302 enters the opening 402 the contacts 408 compress even further to about 0.025 inch, creating additional force between the contacts 408, the test sensor 302, and the generally horizontal surface 406, thus securing the test sensor 302. The contact holder 420 restrains the contacts on three sides, helping to prevent or inhibit permanent deformation of the contacts 408 during operation. As can be seen in FIG. 10, the test sensor would enter the opening 402 along the inclined surface 404. The test sensor then reaches the contacts 408 and displaces the contact 408 such that the contacts 408 further compress and help to secure the test sensor between the contacts 408 and the generally horizontal surface 406 of the test sensor support frame 418. The test sensor continues to move through the opening 402 in the direction of arrow A, until reaching a testing position where the contacts 314 of the test sensor 302 are aligned with the contacts 408 of the multi-contact sensor connector, as shown in FIGS. 8 and 9. To help ensure proper alignment between the contacts 408 of the multi-contact sensor connector 400 and the contacts 314 of the test sensor 302, the contact holder 420 further has a first sidewall 412 and a second sidewall 414 (FIG. 8). The first and second sidewalls 412, 414 are adapted to be spaced apart from each other generally the width of the test sensor 302. By spacing the first and second sidewalls 412, 414 approximately the width of the test sensor 302 apart, the chance of the contacts 314 of the test sensor 302 being laterally misaligned relative to the contacts 408 of the multi-contact sensor connector 400 is greatly reduced, improving the reliability of the performance of the sensor-dispensing instrument. The contacts 408 of the multi-contact sensor connector 400 do not move laterally relative to the sidewalls 412, 414 of the contact holder 420. The fact that the contacts 408 do not move laterally relative to the first and second sidewalls 412, 414 helps to ensure proper electrical connection between the test sensor 302 and the multi-contact sensor connector 400.

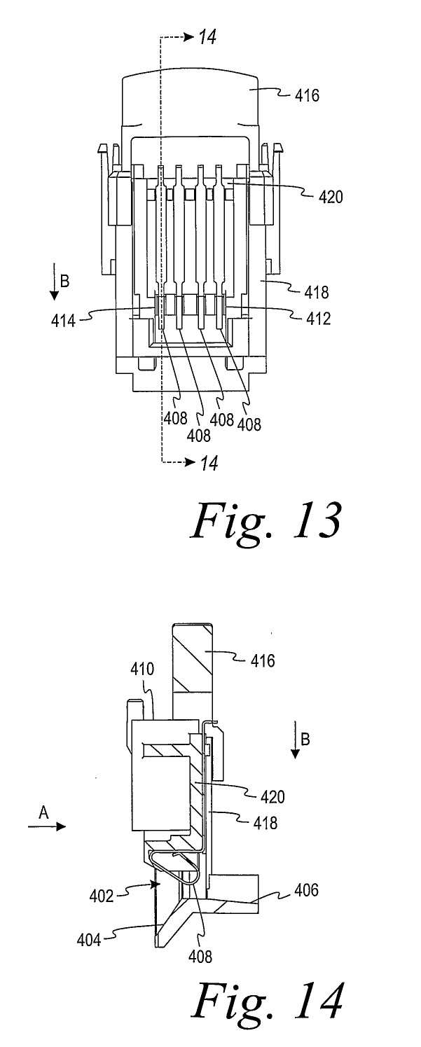

After a sample has been tested by the test sensor 302, a sensor release button 416 is depressed to remove the test sensor from sensor-dispensing instrument. The sensor release button 416 extends beyond an outer surface of an outer housing of the sensor-dispensing instrument. According to one embodiment the sensor release button 416 is spring-loaded to bias the sensor release button 416 to a position extending beyond the outer surface of the outer housing. The sensor release button 416 is adapted to displace the sensor support frame 418 in the direction shown by arrow B in FIGS. 13 and 14. Moving the sensor support frame 418 in the direction of arrow B causes both the inclined surface 404 and the generally horizontal surface 406 to be displaced in the direction of arrow B. Moving the inclined surface 404 and the generally horizontal surface 406 in the direction of arrow B releases the test sensor 302 from between the generally horizontal surface 406 and the plurality of contacts 408 as the generally horizontal surface 406 moves away from the contacts 408 and the contact holder 420. The contacts 408 are not displaced relative to the PCB connector surface 410, but rather the compression is relieved by the movement of the generally horizontal surface 406. Once the test sensor support frame 418 has been displaced in the direction of arrow B, a user may tilt the sensor-dispensing instrument to remove the test sensor 302 without having to directly contact the sensor 302. Once the sensor 302 is removed from the sensor dispensing instrument, the sensor release button 416 is allowed return to its original position, extending beyond the outer housing 12, allowing the sensor support frame 418 to also return to its original position such that the generally horizontal surface 406 compresses the contacts 408.

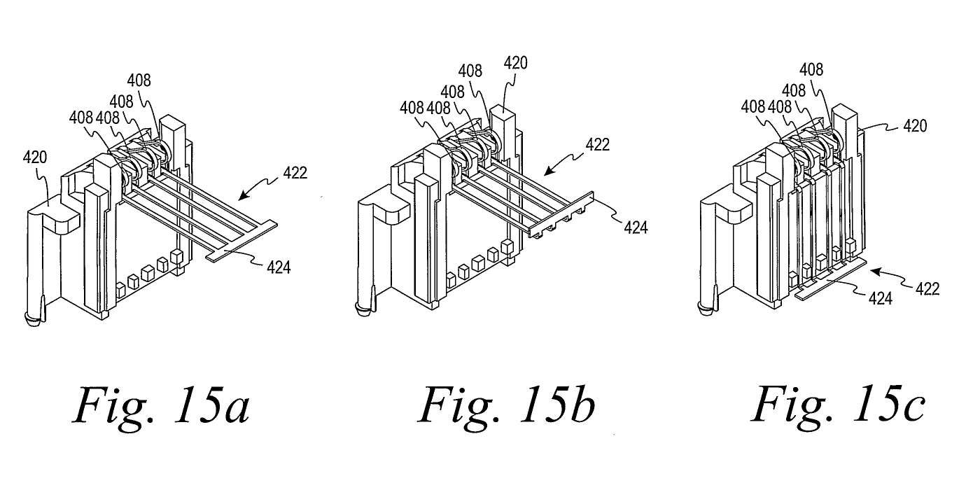

Turning now to FIGS. 15a-15c the assembly of the contacts 408 onto the contact holder 420 is shown. The contacts 408 all have generally identical profiles thus allowing the contacts 408 to be manufactured on the same forming tool at the same time and be connected via a common contact carrier assembly 422. The common contact carrier assembly 422 comprises an attachment member 424 adapted to connect the contacts 408, such that the contacts 408 are all part of the one piece common contact carrier assembly 422.

As shown in FIG. 15a, the common contact carrier assembly 422 is positioned such that the contacts 408 are positioned in the contact holder 420 so that the portion of the contacts 408 that interact with a test sensor are properly positioned for use with the multi-contact sensor connector 400. The common contact carrier assembly 422 provides proper lateral spacing between the contacts 408. Next, as can be seen in FIG. 15b, the attachment member is rotated approximately ninety (90) degrees to allow the contacts 408 to be shaped properly to interact with a printed circuit board. Finally, as depicted in FIG. 15c, the contacts 408 are rotated approximately ninety (90) degrees to be positioned in the location used with the multi-contact sensor connector 400. The attachment member 424 is then removed, electrically isolating each of the contacts 408.

### Alternative Embodiment A

A multi-contact sensor connector for use with a sensor-dispensing instrument adapted to handle a sensor pack containing a plurality of sensors, each of the sensors having a plurality of electrical contacts, the multi-contact sensor connector comprising:

a test sensor support frame forming an opening therethrough, the opening being adapted to allow a test sensor to pass through, the test sensor support frame having an inclined surface region adapted to guide a test sensor into the opening and a generally horizontal surface region adapted to support the test sensor in the opening;

a printed circuit board connector surface;

a plurality of contacts adapted to interact with the electrical contacts of the sensors, the contacts being positioned to secure the test sensor between the contacts and the generally horizontal surface region of the test sensor support frame, the contacts being compressed by the test sensor support frame, the contacts further being fixed relative to the printed circuit board connector surface; and

a contact holder adapted to retain the plurality of contacts and to electrically isolate the respective contacts from one another.

### Alternative Embodiment B

The multi-contact sensor connector of alternative embodiment A wherein the contacts are compressed from about 0.008 inch to about 0.025 inch.

### Alternative Embodiment C

The multi-contact sensor connector of alternative embodiment A wherein the contact holder of the test sensor support frame further has a first sidewall and a second sidewall, the first sidewall being spaced apart from the second sidewall generally a width of the test sensor, the first sidewall and the second sidewall being adapted to laterally position the test sensor relative to the plurality of contacts.

### Alternative Embodiment D

The multi-contact sensor connector of alternative embodiment A further comprising: a sensor release button adapted to displace the sensor support frame from the contacts to release the sensor when the sensor release button is depressed.

### Alternative Embodiment E

The multi-contact sensor connector of alternative embodiment D wherein the sensor release button is spring-loaded to return the sensor support frame to a position such that the contacts are compressed by the sensor support frame when the sensor release button is not depressed.

### Alternative Embodiment F

The multi-contact sensor connector of alternative embodiment D wherein the contacts are fixed in place within a contact holder.

### Alternative Embodiment G

The multi-contact sensor connector of alternative embodiment A wherein the plurality of contacts have generally identical profiles.

### Alternative Embodiment H

A multi-contact sensor connector for use with a sensor-dispensing instrument adapted to handle a sensor pack containing a plurality of sensors, each of the sensors having a plurality of electrical contacts, the multi-contact sensor connector comprising:

a test sensor support frame forming an opening therethrough, the opening being adapted to allow a test sensor to pass through, the test sensor support frame having an inclined surface region adapted to guide a test sensor into the opening and a generally horizontal surface region adapted to support the test sensor in the opening;

a plurality of contacts adapted to interact with the electrical contacts of the sensors, the contacts being fixedly positioned opposite the generally horizontal surface region of the test sensor support frame to secure the test sensor between the contacts and the generally horizontal surface region of the test sensor support frame, the contacts being compressible by the test sensor support frame;

a contact holder adapted to retain the plurality of contacts, the contact holder having a first sidewall and a second sidewall; and

a sensor release button adapted to vertically displace the sensor support frame from the contacts, thereby releasing the test sensor when the sensor release button is depressed;

wherein, the first sidewall and the second sidewall are adapted to laterally position the test sensor relative to the plurality of contacts.

### Alternative Embodiment I

The multi-contact sensor connector of alternative embodiment H wherein the contacts are compressed from about 0.008 inch to about 0.025 inch.

### Alternative Embodiment J

The multi-contact sensor connector of alternative embodiment H wherein the sensor release button is spring-loaded to return the sensor support frame to a position such that the contacts are compressed by the sensor support frame when the sensor release button is not depressed.

### Alternative Embodiment K

The multi-contact sensor connector of alternative embodiment H wherein the plurality of contacts are contained within a contact holder adapted to electrically isolate the respective contacts.

### Alternative Embodiment L

An electrical contact carrier assembly for use with a multi-contact sensor connector comprising:

a plurality of electrical contacts having a generally identical profile; and

a removable attachment member adapted to removably connect the plurality of electrical contacts and providing proper lateral spacing between the contacts.

While the invention is susceptible to various modifications and alternative forms, specific embodiments and methods thereof have been shown by way of example in the drawings and are described in detail herein. It should be understood, however, that it is not intended to limit the invention to the particular forms or methods disclosed, but, to the contrary, the intention is to cover all modifications, equivalents and alternatives falling within the spirit and scope of the invention as defined by the appended claims.

1. A multi-contact sensor connector for use with a sensor-dispensing instrument adapted to handle a sensor pack containing a plurality of sensors, each of the sensors having a plurality of electrical contacts, the multi-contact sensor connector comprising:
a test sensor support frame forming an opening therethrough, the opening being adapted to allow a test sensor to pass through, the test sensor support frame having an inclined surface region adapted to guide a test sensor into the opening and a generally horizontal surface region adapted to support the test sensor in the opening;
a printed circuit board connector surface;
a plurality of contacts adapted to interact with the electrical contacts of the sensors, the contacts being positioned to secure the test sensor between the contacts and the generally horizontal surface region of the test sensor support frame, the contacts being compressed by the test sensor support frame, the contacts further being fixed relative to the printed circuit board connector surface; and
a contact holder adapted to retain the plurality of contacts and to electrically isolate the respective contacts from one another.

2. The multi-contact sensor connector of claim 1, wherein the contacts are compressed from about 0.008 inch to about 0.025 inch.

3. The multi-contact sensor connector of claim 1, wherein the contact holder of the test sensor support frame further has a first sidewall and a second sidewall, the first sidewall being spaced apart from the second sidewall generally a width of the test sensor, the first sidewall and the second sidewall being adapted to laterally position the test sensor relative to the plurality of contacts.

4. The multi-contact sensor connector of claim 1, further comprising:
a sensor release button adapted to displace the sensor support frame from the contacts to release the sensor when the sensor release button is depressed.

5. The multi-contact sensor connector of claim 4, wherein the sensor release button is spring-loaded to return the sensor support frame to a position such that the contacts are compressed by the sensor support frame when the sensor release button is not depressed.

6. The multi-contact sensor connector of claim 4, wherein the contacts are fixed in place within a contact holder.

7. The multi-contact sensor connector of claim 1, wherein the plurality of contacts have generally identical profiles.

8. A multi-contact sensor connector for use with a sensor-dispensing instrument adapted to handle a sensor pack containing a plurality of sensors, each of the sensors having a plurality of electrical contacts, the multi-contact sensor connector comprising:
a test sensor support frame forming an opening therethrough, the opening being adapted to allow a test sensor to pass through, the test sensor support frame having an inclined surface region adapted to guide a test sensor into the opening and a generally horizontal surface region adapted to support the test sensor in the opening;
a plurality of contacts adapted to interact with the electrical contacts of the sensors, the contacts being fixedly positioned opposite the generally horizontal surface region of the test sensor support frame to secure the test sensor between the contacts and the generally horizontal surface region of the test sensor support frame, the contacts being compressible by the test sensor support frame;
a contact holder adapted to retain the plurality of contacts, the contact holder having a first sidewall and a second sidewall; and
a sensor release button adapted to vertically displace the sensor support frame from the contacts, thereby releasing the test sensor when the sensor release button is depressed;
wherein, the first sidewall and the second sidewall are adapted to laterally position the test sensor relative to the plurality of contacts.

9. The multi-contact sensor connector of claim 8, wherein the contacts are compressed from about 0.008 inch to about 0.025 inch.

10. The multi-contact sensor connector of claim 8, wherein the sensor release button is spring-loaded to return the sensor support frame to a position such that the contacts are compressed by the sensor support frame when the sensor release button is not depressed.

11. The multi-contact sensor connector of claim 8, wherein the plurality of contacts are contained within a contact holder adapted to electrically isolate the respective contacts.

12. An electrical contact carrier assembly for use with a multi-contact sensor connector comprising:
a plurality of electrical contacts having a generally identical profile; and
a removable attachment member adapted to removably connect the plurality of electrical contacts and providing proper lateral spacing between the contacts.
